(19) United States
(12) Patent Application Publication
(10) Pub. No.: US 2025/0240186 A1
(43) Pub. Date: Jul. 24, 2025

(54) COMMUNITY IDENTIFIER OF A GROUP OF CLIENT DEVICES

(71) Applicant: HEWLETT PACKARD ENTERPRISE DEVELOPMENT LP, Spring, TX (US)

(72) Inventors: Haifeng Zhang, Beijing (CN); Hao Lu, Fremont, CA (US); Xuanhe Zhang, Beijing (CN); Hong Song, Beijing (CN); Piyush Agarwal, Santa Clara, CA (US); Yan Liu, Beijing (CN)

(21) Appl. No.: 18/417,500

(22) Filed: Jan. 19, 2024

(51) Int. Cl. H04L 12/46; H04W 12/069

(52) U.S. Cl. CPC H04L 12/4641; H04L 12/4633; H04W 12/069

(57) ABSTRACT

In some examples, a system initiates an authentication procedure for a client device, and determines a group of client devices including the client device based on information associated with the client devices. The system assigns, to the client device, a community identifier as part of the authentication procedure, where the community identifier identifies the group of client devices that are able to communicate with one another over a virtual network.

### BACKGROUND

Electronic devices are able to communicate over networks, including wired networks or wireless networks. A network includes network devices to which electronic devices are able to connect, to allow the electronic devices to communicate over the network.

### BRIEF DESCRIPTION OF THE DRAWINGS

Some implementations of the present disclosure are described with respect to the following figures.

FIG. 1 is a block diagram of a network arrangement including personal area networks (PANs), according to some examples.

FIG. 2 is a message flow diagram of a process of obtaining a community identifier according to some examples.

FIG. 3 is a block diagram of an encapsulation of a packet, in accordance with some examples.

FIG. 4 and FIG. 5 are message flow diagrams of processes of forwarding packets, according to some examples.

FIG. 6 is a block diagram of a network arrangement including access points (APs) between which a client device transitions, according to some examples.

FIG. 7 is a block diagram of a storage medium storing machine-readable instructions according to some examples.

FIG. 8 is a block diagram of a network device according to some examples.

FIG. 9 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A virtual network may be established within a physical network, which can be a physical wired network or physical wireless networks. For example, a virtual local area network (VLAN) can be established within a wireless network such as a wireless local area network (WLAN) (also referred to as a Wi-Fi network). A VLAN operates at layer 2 of the Open Systems Interconnect (OSI) model. Multiple VLANs can be established in a WLAN or across multiple WLANs. The multiple VLANs can have different functional and security configurations, for example. Although some examples herein refer to use of VLANs in a WLAN as a physical network, in other examples, VLANs can be used in other types of wireless networks (such as cellular networks), or in wired networks.

In some examples, network virtualization can operate according to the Virtual extensible LAN (VXLAN) protocol, which is a tunneling protocol that provides an underlay and overlay network in which an overlay network carries layer 2 (L2) data frames (e.g., Ethernet data frames) in tunnels over a layer 3 (L3) network (an underlay network), such as an Internet Protocol (IP) network. A version of VXLAN is described in Request for Comments (RFC) 7348, entitled “Virtual extensible Local Area Network (VXLAN): A Framework for Overlaying Virtualized Layer 2 Networks over Layer 3 Networks,” dated August 2014. Based on use of an underlay and overlay network (in which an L2 network overlays an L3 network), L2 virtual networks such as VLANs can span across the L3 network, possibly across different physical domains (e.g., different data centers, different campuses, different geographic sites, and so forth).

There may be many client devices operating within a given virtual network, such as a VLAN deployed in a VXLAN underlay and overlay network. In some cases, client devices on a virtual network may be grouped into different groups to isolate the client devices of the different groups, which can be performed for security purposes (e.g., to prevent client devices of a first group from receiving data communicated among client devices of a second group). In some examples, a VXLAN group based policy (GBP) can be used to split client devices on the same virtual network into multiple groups.

To support VXLAN GBP, a network device (such as an access point (AP) or another type of network device) to which client devices are able to establish connectivity is configured to act as a virtual tunnel endpoint (VTEP), and a network administrator may manually establish group identifiers (IDs) that define respective different groups of client devices. A VTEP performs VXLAN encapsulation and decapsulation. VXLAN encapsulation encapsulates a packet by adding a VXLAN header, and VXLAN decapsulation decapsulates a VXLAN-encapsulated packet by removing the VXLAN header. Having to manually configure group IDs for VTEPs in network devices (e.g., APs, etc.) of a VXLAN underlay and overlay network to support grouping according to the VXLAN GBP adds to the complexity of setting up the virtual network. The group IDs can be set according to policies manually configured by the network administrator. Depending on the number of client devices, the network administrator may have to configure a large number of policies, which adds to complexity.

In accordance with some implementations of the present disclosure, automated segmentation is performed in a virtual network such as a VLAN to split client devices operating in the virtual network into multiple groups. In some examples, the automated segmentation is performed by assigning community identifiers to respective groups of client devices. A community identifier is assigned to a group of client devices that are able to interact (e.g., discover, communicate, or other interaction) with one another in the virtual network. Client devices in a first group are unable to interact with client devices in a second group in the virtual network. In some examples, a community identifier includes an identifier of a personal area network (PAN) (“PAN ID”) that defines a community of client devices that are able to interact with one another. The assignment of community identifiers such as PAN IDs to client devices can be automatically performed during authentication procedures for the client devices. For example, an authentication procedure may assign a shared secret to a client device, where the shared secret can be a Multi Pre-Shared Key (MPSK). In such examples, a community identifier (e.g., a PAN ID) may be determined based on a shared secret assigned to the client device. In other examples, a community identifier (e.g., a PAN ID) may be assigned based on user information carried in an authentication message of an authentication procedure, such as a Remote Authentication Dial-In User Service (RADIUS) authentication procedure.

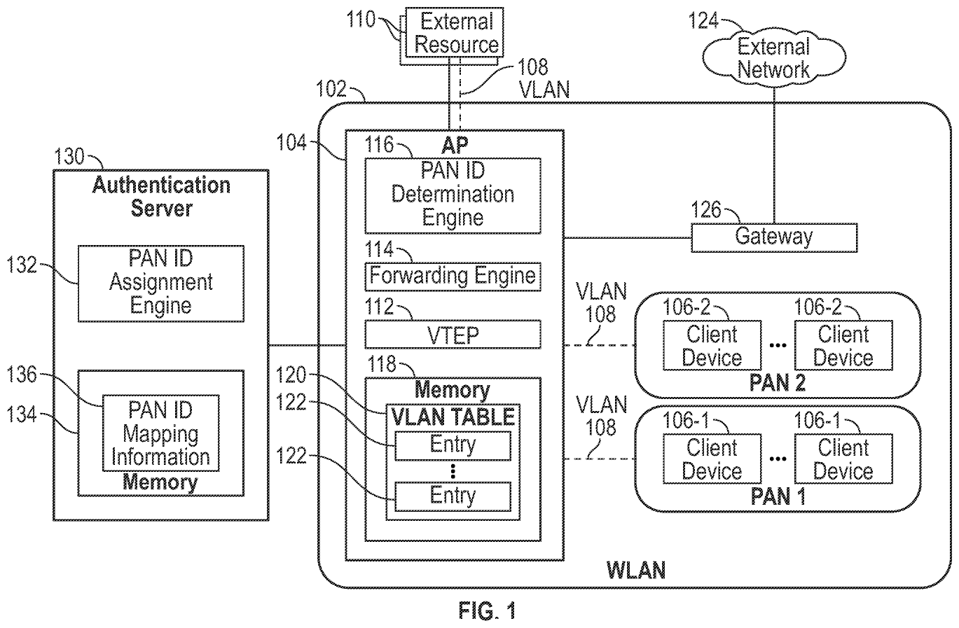

FIG. 1 is a block diagram of an example network arrangement that includes a WLAN 102 that has an AP 104 that is able to establish wireless connectivity to various client devices (CDs) 106-1 and 106-2. Although just one AP is shown in FIG. 1, in other examples, there may be more than one AP in the WLAN 102. Further, there may be multiple WLANs present in a network arrangement, where each WLAN includes one or more APs.

In alternative examples, client devices can communicate in another type of wireless network, such as a cellular network or another wireless network. In further examples, client devices can communicate in a wired network by establishing a connection with a network device such as a switch.

A “client device” can refer to any electronic device that is able to establish connectivity with an AP (or another type of network device). Examples of electronic devices can include any or some combination of the following: a computer (e.g., a desktop computer, a server computer, a notebook computer, a tablet computer, or another type of computer), a smartphone, an Internet of Things (IoT) device, a household appliance, a game appliance, a vehicle, or any other type of electronic device.

The client devices 106-1 and 106-2 are able to communicate over a VLAN 108 (or another type of virtual network). Although FIG. 1 shows an example with four client devices 106-1 and 106-2, there may be many (e.g., hundreds, thousands, tens of thousands, etc.) client devices that are able to communicate over the VLAN 108.

In some examples, the network arrangement of FIG. 1 supports network virtualization according to the VXLAN protocol, in which an overlay network (including tunnels) can be established over an underlay network. The WLAN 102 is a physical network, and an L3 network is established in the physical network. On top of the L3 network is an L2 network according to the VXLAN protocol.

The VLAN 108 is deployed in the VXLAN underlay an overlay network. Although just one VLAN 108 is depicted in FIG. 1, note that multiple VLANs may be deployed in further examples. In some examples, the VLAN 108 may extend across multiple physical domains, including different WLANs in different data centers, different campuses, different geographic sites, and so forth.

To support the VXLAN protocol, the AP 104 includes a VTEP 112, which is able to perform VXLAN encapsulation and the encapsulation of packets. A “packet” can refer to any unit of data that can be separately communicated through a network. A packet may be an L2 packet, such as an Ethernet data frame that carries an Ethernet header and a payload. L2 packets may be forwarded by the AP 104 using Media Access Control (MAC) addresses in the L2 packets. Alternatively, a packet may be an L3 packet, such as an Internet Protocol (IP) packet that carries an IP header and a payload. Note that the IP packet may be encapsulated by an L2 header. IP packets may be forwarded by the AP 104 using IP addresses in the IP packets.

The AP 104 may receive a packet from a client device (e.g., 106-1 or 106-2). If VXLAN encapsulation is to be applied, the AP 104 can encapsulate the packet with a VXLAN header, and a forwarding engine 114 in the AP 104 can forward the encapsulated packet to a destination device, which may be another client device or any other target electronic device. Note that in some cases (discussed further below), VXLAN encapsulation is not to be applied by the AP 104, in which case the forwarding engine 114 in the AP 104 would forward the packet without VXLAN encapsulation to a destination device.

The AP 104 may also receive a VXLAN encapsulated packet from a source, such as from a switch in a gateway 126. A “gateway” refers to a network infrastructure that is to communicate packets between one VLAN and an external network or between different VLANs. The network infrastructure of the gateway 126 may include one or more switches (more generally referred to as a “switch infrastructure”). A switch can include an L2 switch, an L3 router, or any other type of network device.

The VTEP 112 can decapsulate a received VXLAN encapsulated packet to remove the VXLAN header, which produces a decapsulated packet. The forwarding engine 114 can forward the decapsulated packet to a destination device, such as any of client devices 106-1 and 106-2.

The forwarding engine 114 can forward a packet using one or more network addresses (e.g., MAC addresses, IP addresses, etc.) in the packet. The forwarding engine 114 uses forwarding information (e.g., a forwarding table, a routing table, etc.) that can be accessed by the forwarding engine 114 to determine where a packet is to be forwarded based on one or more network addresses in the packet. The forwarding information may be stored in a memory 118 of the AP 104.

A memory may be implemented using one or more memory devices, such as any or some combination of a dynamic random access memory (DRAM) device, a static random access memory (SRAM) device, a flash memory device, or another type of memory device.

As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

The network arrangement of FIG. 1 includes an authentication server 130, which provides authentication services, including authentication of the client devices 106-1 and 106-2. In some examples, the authentication server 130 can reside in a cloud computing environment, in which case the authentication server 130 is referred to as a cloud authentication server. In other examples, the authentication server 130 can be implemented in a different computing environment, such as a data center, a home, an office, or any other location. A “server” can be implemented with a collection of computers. As used here, a “collection” of items can refer to a single item or multiple items; thus, a collection of computers can refer to a single computer or multiple computers.

In some examples, the authentication server 130 is a Remote Authentication Dial-In User Service (RADIUS) server. RADIUS refers to a networking protocol that provides authentication, authorization, and accounting (AAA) management for clients. In other examples, a different authentication protocol may be employed by the authentication server 130.

In accordance with some implementations of the present disclosure, automated segmentation of a VLAN (e.g., 108) can be performed, based on use of community identifiers (IDs) that identify respective groups of client devices. The automated segmentation of the VLAN 108 is performed based on automatically assigning community identifiers to define groups of electronic devices, where the groups of client devices are determined based on information associated with the client devices. The information associated with the client devices can include any or some combination of the following: information (e.g., an identifier such as a username) of a user to which a client device belongs, a type (e.g., a smartphone, a tablet, a notebook computer, server computer, etc.) of a client device, a location of a client device, an organization that a client device is associated with, or any other information associated with a client device.

The assignment of the community identifier to a client device can be performed as part of an authentication procedure for the client device performed with the authentication server 130.

In some examples, the community ID is a personal area network (PAN) ID, which identifies a PAN that the client device is part of. As shown in FIG. 1, the client devices 106-1 are part of PAN 1, and the client devices 106-2 are part of PAN 2. Although just two PANs are shown in FIG. 1, in further examples, there may be more than two PANs. The auto-segmentation of a VLAN according to some implementations of the present disclosure defines multiple PANs of client devices (or more generally, multiple communities of client devices) that are identified by respective PAN IDs (or more generally, community IDs).

A PAN refers to a network that links client devices sharing some characteristic, such as client devices within an immediate vicinity of a user or some other entity, a type of client devices, client devices that belong to a given user, an organization that client devices are part of, and so forth. Client devices that are part of the same PAN are able to interact with one another, but are unable to interact with client devices in other PANs. PANs provide isolation of groups of client devices; in other words, client devices in one PAN are isolated from client devices in other PANs. PANs also protect the privacy or implement security between the groups of client devices.

Note that client devices of a given PAN may also be able to interact with one or more external resources 110 if allowed by a PAN policy associated with the given PAN. The PAN policy may be defined by a network administrator or another entity (a program or a machine), for example. Examples of the external resources 110 include any or some combination of the following: a printer, a file (or other data object), a program (e.g., an antivirus program or another type of program), a storage resource, a processing resource, a network resource, a web resource, a cloud resource, or any other type of resource. More generally, an “external resource” refers to a resource that is external of a PAN but is accessible by client devices in the PAN.

In accordance with some implementations of the present disclosure, the AP 104 further includes a PAN ID determination engine 116, which is able to determine PAN IDs for client devices based on (1) a shared secret such as a pre-shared key (PSK) assigned to a client device, or (2) information of a user of a client device.

A PSK is also referred to as a passphrase, which is a shared secret sent by a client device to an AP to allow the client device to connect to the AP and perform secure communications between the client device and the AP. The secure communications can be accomplished by encrypting data using keys. The PSK includes a sequence of characters (e.g., letters, numerals, symbols, etc.) having a length that is within a specified length range. A WLAN (such as the WLAN 102) that supports a multi-PSK (MPSK) arrangement allows use of multiple PSKs, where each PSK (referred to as an MPSK when used in an MPSK arrangement) can be associated with a group of client devices. Thus, multiple MPSKs can be assigned to respective groups of client devices, such as respective PANs. In some examples, a PAN ID can be assigned to a client device based on an MPSK assigned to the client device.

In other examples, a PAN ID can be assigned to a client device based on information of a user (“user information”) of the client device. The user information can be based on a username of the client device. In some examples, the information based on the username of the client device may be any or some combination of: (1) the username, (2) a password bound to the username, or (3) a fingerprint computed based on the password bound to the username. In other examples, other information based on the username of the client device may be employed.

The PAN ID determination engine 116 is able to determine a PAN ID for a client device based on obtaining the PAN ID from the authentication server 130. The authentication server 130 includes a PAN ID assignment engine 132 that assigns a PAN ID to a client device during an authentication procedure for the client device that is performed with the authentication server 130. The authentication server 130 includes a memory 134 that stores PAN ID mapping information 136 (e.g., in the form of a mapping table or any other data structure) that maps different PAN IDs to MPSKs or different user information. Based on an MPSK assigned to a client device by the authentication server 130 during an authentication procedure, or based on user information received in an authentication message from the client device, the PAN ID assignment engine 132 retrieves the corresponding PAN ID from a respective entry of the PAN ID mapping information 136. An entry of the PAN ID mapping information 136 correlates a PAN ID to a respective MPSK or user information. Different entries of the PAN ID mapping information 136 correlate different PAN IDs to different MPSKs or different user information.

In alternative examples, the assignment of PAN IDs to client devices can be performed in the AP 104 instead of in the authentication server 130. In such alternative examples, the PAN ID determination engine 116 implements the functionality of the PAN ID assignment engine 132, and the PAN ID mapping information may be stored in the memory 118 of the AP 104.

The memory 118 in the AP 104 further stores a VLAN table 120 (or another type of data structure) that contains entries 122 including information for client devices that are part of a given VLAN (e.g., the VLAN 108). Different VLAN tables are used for different VLANs. Each entry 122 of the VLAN table 120 contains information that correlates a PAN ID to an identifier (e.g., a network address such as a MAC address or another type of identifier) of a respective client device (any of 106-1 or 106-2 in the example of FIG. 1). If VXLAN encapsulation is to be performed of a packet received from a given client device (106-1 or 106-2), the VTEP 112 accesses the entry 122 corresponding to the given client device and adds the PAN ID in the accessed entry 122 to a VXLAN header that is added to the packet (discussed further below).

Note that in some cases, the AP 104 does not apply VXLAN encapsulation to a received packet. For example, if the AP 104 determines that the received packet is to be sent to an external network 124 (e.g., the Internet) or another VLAN (different from the VLAN 108), then VXLAN encapsulation is not applied by the AP 104. In some examples, a packet sent to the external network 124 or sent as part of inter-VLAN communications (communications among different VLANs) has a destination network address (e.g., a destination MAC address) that is a network address of the gateway 126. If a packet contains a destination MAC address that matches the gateway MAC address of the gateway 126, then the AP 104 does not apply VXLAN encapsulation to the packet. In other examples, VXLAN encapsulation is not applied to the following types of packets: (1) a Dynamic Host Configuration Protocol (DHCP) packet (a DHCP packet is indicated by DHCP protocol information in the packet), (2) an Address Resolution Protocol (ARP) packet containing a destination IP address of the gateway 126 (an ARP packet is indicated by ARP protocol information in the packet), or (3) any other designated type of packet.

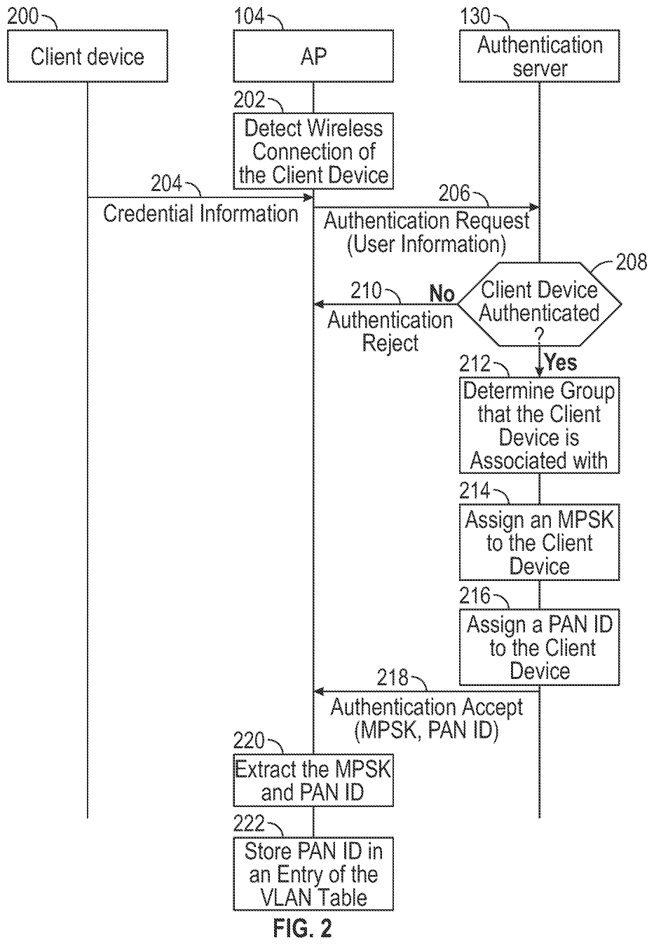

FIG. 2 is a flow diagram of a process of obtaining a PAN ID (or more generally, a community ID) for a client device 200, where the obtained PAN ID identifies a PAN that the client device 200 is part of. The client device 200 may be one of the client devices 106-1 or 106-2 of FIG. 1. Although FIG. 2 shows a specific order of tasks, note that in other examples, the tasks may be performed in a different order, some of the tasks may be omitted, or other tasks may be added.

The obtaining of the PAN ID to the client device 200 according to FIG. 2 may be based on an MPSK (or more generally, a shared secret) assigned to the client device 200 during an authentication procedure performed for the client device 200 with the authentication server 130. The MPSK is assigned by the authentication server 130 to a group of client devices, such as a PAN including multiple client devices. More generally, the authentication server 130 may assign a shared secret to a group of client devices, where the assigned shared secret is used by the client device 200 to gain secure access to the AP 104.

As shown in FIG. 2, the AP 104 detects (at 202) that the client device 200 is wirelessly connected to the AP 104. At this initial stage of the wireless connection of the client device 200 with the AP 104, the client device 200 has not yet been authenticated and thus is not allowed access to network resources, such as resources of the WLAN 102. Prior to authentication, the client device 200 is unable to communicate with other devices over the WLAN 102.

Based on detecting the client device, the AP 104 triggers an authentication procedure for the client device 200. In some examples, the AP 104 may trigger the authentication procedure in response to receiving (at 204) credential information from the client device 200, where the credential information can include a username and password provided by a user of the client device 200.

The triggered authentication procedure involves the AP 104 sending (at 206) an authentication request message to the authentication server 130. The authentication request message may be a RADIUS access-request message, for example. The authentication request message includes user information based on the credential information from the client device 200. For example, the user information can include the username and the password of the credential information, or alternatively, the user information can include the username and a fingerprint of the password.

An example of a fingerprint can include a hash value produced by applying a hash function (e.g., a cryptographic hash function such as a Secure Hash Algorithm (SHA) function) to an input value, which in the above example includes a password bound to a username. In some examples, the authentication server 130 may present a portal (e.g., a web interface or another type of interface) that allows the user (of the client device 200) to bind the user's username to a password (note that the password can be entered by the user or otherwise generated for the user). “Binding” a password to a username refers to associating the password with the username such that provision of both the username and the associated password to the authentication server 130 during an authentication procedure would allow the authentication server 130 to authenticate the client device 200. In some examples, instead of carrying the username and the password in the authentication request message, the authentication request message can include the username and a fingerprint of the password.

In some examples, the user information may be included in one or more vendor-specific attributes (VSAs) of the RADIUS access-request message. A VSA includes a parameter that is to be communicated between an authentication server and a network access server, such as the AP 104. A “network access server” refers to an entity that is between a client device and an authentication server. More generally, the user information is carried in respective fields of the authentication request message. In some cases, the user information may be encrypted in the authentication request message, to protect the user information unauthorized access.

In response to the authentication request message, the authentication server 130 determines (at 208), based on the user information included in the authentication request message, whether the client device 200 is authenticated. If the client device 200 is not authenticated, the authentication server sends (at 210) an authentication reject message, such as a RADIUS access-reject message. The authentication reject message causes the AP 104 to prevent the client device 200 from accessing the WLAN 102.

If the client device 200 is authenticated based on the user information, the authentication server 130 determines (at 212) a group that the client device 200 is associated with. The determination of the group can be based on information associated with the client device 200, such as any or some combination of the following: information (e.g., an identifier such as a username) of a user to which a client device 200 belongs, a type of the client device 200, a location of the client device 200, an organization that the client device 200 is associated with, or any other information associated with a client device 200. For example, the authentication server 130 can determine that client devices belonging to an individual user or a collection of users are part of a given group of client devices. As another example, the authentication server 130 can determine that client devices within a specified proximity of an entity (e.g., a person or machine) are part of a given group of client devices.

Based on the determined group, the authentication server 130 assigns (at 214) an MPSK to the client device 200. Note that different groups of client devices are assigned different MPSKs. As a result, the MPSK assigned to the client device 200 by the authentication server is the MPSK associated with the group that the client device 200 is part of. The PAN ID assignment engine 132 in the authentication server 130 further assigns (at 216) a PAN ID to the client device 200 based on the MPSK assigned to the client device 200. More specifically, the PAN ID assignment engine 132 retrieves an entry from the PAN ID mapping information 136, where the retrieved entry correlates the assigned MPSK to a given PAN ID. The PAN ID assignment engine 132 assigns the given PAN ID in the retrieved entry to the client device 200.

The authentication server 130 sends (at 218) an authentication accept message (e.g., a RADIUS access-accept message) to the AP 104. The authentication accept message carries the assigned MPSK and the assigned PAN ID. In some examples, the assigned MPSK and the assigned PAN ID may be included in VSAs of the RADIUS access-accept message. More generally, the assigned MPSK and the assigned PAN ID are carried in respective fields of the authentication accept message. In some cases, the assigned MPSK and the assigned PAN ID may be encrypted in the authentication accept message, to protect the MPSK and the PAN ID from unauthorized access.

In response to receiving the authentication accept message, the AP 104 extracts (at 220) the assigned MPSK and the assigned PAN ID. The AP 104 decrypts the extracted MPSK and PAN ID if the MPSK and PAN ID were encrypted in the authentication accept message. The AP 104 stores (at 222) the PAN ID assigned to the client device 200 in an entry 122 of the VLAN table 120. The PAN ID stored in the entry 122 of the VLAN table 120 can be later used at the AP 104 to perform VXLAN encapsulation of a packet (discussed further below).

The AP 104 and the client device 200 use the assigned MPSK to perform an access process according to a wireless security protocol between the client device 200 and the AP 104. In some examples, the wireless security protocol that is employed between the client device 200 and the AP 104 is a Wi-Fi Protected Access 2 (WPA2) wireless security protocol. WPA2 is used to maintain communications between client devices and the AP 104 secure, such as by using encryption. A WPA2 access process includes a 4-way handshake between the client device 200 and the AP 104, in which 4 messages are exchanged between the client device 200 and the AP 104 for exchanging specific information between the client device 200 and AP 104 to enable the client device 200 and the AP 104 to perform encrypted communications. In other examples, other wireless security protocols may be employed between client devices and APs or other types of network devices.

In alternative examples, instead of assigning a PAN ID to the client device 200 based on the MPSK assigned to the client device 200, a PAN can be assigned to the client device 200 based on information of a user (“user information”) of the client device 200. As noted above, the user information may be any or some combination of: (1) a username of the user of the client device 200, (2) a password bound to the username, or (3) a fingerprint computed based on the password bound to the username.

As noted above, the user information can be included in the authentication request message sent (at 206) in FIG. 2. In some examples, the user information is included in one or more VSAs of the RADIUS access-request message. Upon receiving the user information and assuming the authentication server 130 has authenticated the client device 200 based on the user information, the PAN ID assignment engine 132 can assign the PAN ID to the client device 200 based on the user information. In such examples, the PAN ID mapping information 136 includes entries that map different PAN IDs to different user information (e.g., different usernames, different combinations of usernames and associated passwords, or different combinations of usernames and fingerprints computed based on passwords bound to respective usernames).

Based on the user information included in the authentication request message, the PAN ID assignment engine 132 can retrieve a corresponding entry from the PAN ID mapping information 136, where the retrieved entry correlates the user information to a given PAN ID. The PAN ID assignment engine 132 assigns the given PAN ID to the client device 200. The given PAN ID can be sent from the authentication server 130 to the AP 104 in an authentication accept message (similar to the authentication accept message sent at 218 in FIG. 2).

As noted above, the auto-segmentation of the VLAN 108 into multiple groups of client devices (e.g., the multiple PANs of client devices depicted in FIG. 1) allows a network arrangement to restrict client device interactions such that client devices are able to interact with just other client devices within the same group, or with designated external resource(s) (e.g., 110). To enforce the foregoing restrictions, a community identifier (e.g., a PAN ID) may be added in an encapsulation header that is added to a packet transmitted by a client device. The encapsulation header may be a VXLAN header in examples where VXLAN encapsulation is performed, such as by the AP 104.

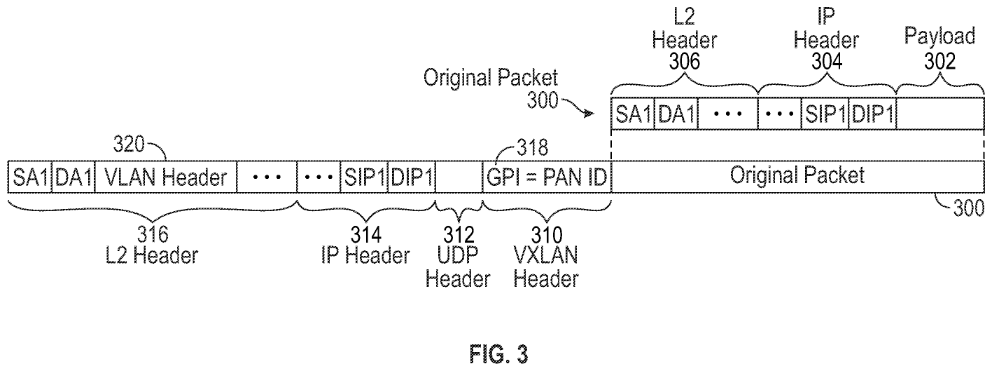

FIG. 3 shows an example of how an original packet 300 (sent from a source client device such as any of 106-1 or 106-2) is VXLAN encapsulated by an AP (such as by the VTEP 112 of the AP 104). In different examples, an encapsulation of a packet may be performed differently.

The original packet 300 of FIG. 3 is an IP packet including a payload 302, an IP header 304, and an L2 header 306 (e.g., an Ethernet header). The payload 302 carries data to be communicated by the source client device. The IP header 304 includes a source IP address (SIP1) and a destination IP address (DIP1), along with other IP header information. The L2 header 306 includes a source MAC address (SA1) and a destination MAC address (DA1), along with other L2 header information. The source MAC address (SA1) is the MAC address of the source client device, and the destination MAC address (DA1) is the MAC address of a destination device to which the original packet 300 is to be sent. The source IP address (SIP1) is an IP address associated with the source client device, and the destination IP address (DIP1) is an IP address associated with the destination device.

The VXLAN encapsulation performed by the VTEP 112 adds a VXLAN header 310, a User Datagram Protocol (UDP) header 312, an outer IP header 314, and an outer L2 header 316. The VXLAN header 310 includes various information associated with the VXLAN protocol, including, as examples, a virtual network identifier (VNI) that can be used to identify a tunnel of an overlay network that is established on an underlay network. The VXLAN header 310 also includes a group policy identifier (GPI) field 318 associated with the VXLAN group based policy (GBP). A value in the GPI field 318 can be used to identify a group. In accordance with some implementations of the present disclosure, the GPI field 318 of the VXLAN header 310 is set to the PAN ID (or more generally, a community ID) of the source client device that transmitted the original packet 300.

As noted above, each entry 122 of the VLAN table 120 correlates an identifier (e.g., a network address such as a MAC address or another type of identifier) of a respective client device to a PAN ID of the respective client device. For example, the VTEP 112 can retrieve an entry 122 of the VLAN table 120 that corresponds to the source MAC address (SA1) of the source client device. The VTEP 112 extracts the PAN ID from the retrieved entry 122 that maps the PAN ID to the source MAC address (SA1), and adds the extracted PAN ID to the GPI field 318 of the VXLAN header 310.

The UDP header 312 includes UDP information, such as a UDP port number. The source IP address (SIP1) and destination IP address (DIP1) of the original packet 300 are copied as the source IP address (SIP1) and destination IP address (DIP1) of the outer IP header 314. Similarly, the source MAC address (SA1) and destination MAC address (DA1) of the original packet 300 are copied as the source MAC address (SA1) and destination MAC address (DA1) of the outer L2 header 316. Additionally, a VLAN header 320 containing VLAN information (including a VLAN ID of a VLAN) is added to the outer L2 header 316.

An AP (“destination AP”) receiving a VXLAN encapsulated packet from another AP (“source AP”) can use the PAN ID in the GPI field 318 to determine whether the destination device (identified by DA1) is in the same PAN as the source client device that transmitted the original packet 300. If not, the destination AP can drop the packet. If the destination device is in the same PAN as the source client device, the destination AP forwards the packet (after decapsulation to obtain the original packet 300) to the destination device.

Although FIG. 3 shows an example in which the original packet 300 is an IP packet, in other examples, an original packet transmitted by a source client device may be an L2 packet (i.e., a packet without an L3 header). Such an L2 packet may be VXLAN encapsulated with a VXLAN header (similar to 310 in FIG. 3) that includes a GPI field set to the PAN ID of the PAN in which the source client device is part of.

In the ensuing discussion, a VXLAN encapsulation in which a PAN ID is added to the GPI field of the VXLAN header is referred to as “PAN encapsulation.”

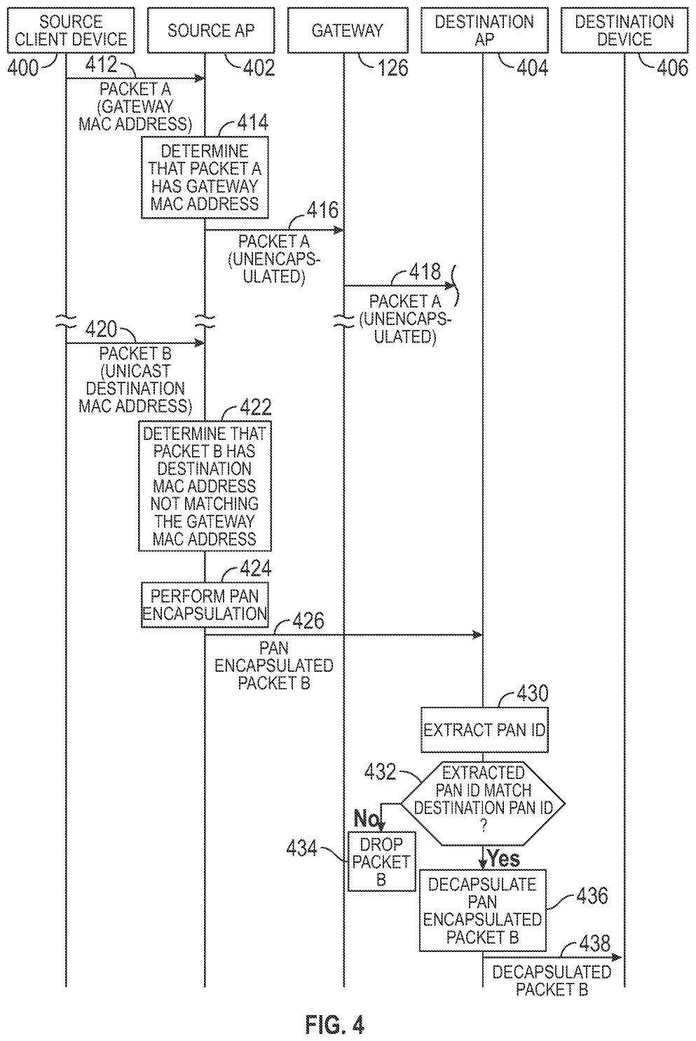

FIG. 4 is a flow diagram of a process of forwarding packets sent by a source client device 400, which can be any of the client devices 106-1 and 106-2 of FIG. 1. Although FIG. 4 shows a specific order of tasks, note that in other examples, the tasks may be performed in a different order, some of the tasks may be omitted, or other tasks may be added.

The source client device 400 sends (at 412), to a source AP 402, packet A that has a unicast destination MAC address that matches the MAC address of the gateway 126 (“gateway MAC address”). The source AP 402 is the AP to which the source client device 400 is wirelessly connected.

Any packet from the source client device 400 that is targeted to an external network (e.g., 124 in FIG. 1) or is an inter-VLAN packet (a packet that is sent from a device in a first VLAN to a device in a second VLAN) includes a unicast destination MAC address that is the gateway MAC address. This allows the packet to be forwarded to the gateway 126 for routing the packet to the external network or to another VLAN.

In response to receiving packet A, the forwarding engine (e.g., similar to 114 in FIG. 1) in the source AP 402 determines (at 414) that packet A has the unicast destination MAC address that matches the gateway MAC address. The MAC address of the gateway 126 may be saved in the memory 118 of the source AP 402. Based on determining that the unicast destination MAC address of packet A matches the gateway MAC address, the forwarding engine in the source AP 402 makes a determination to not perform PAN encapsulation, and forwards (at 416) unencapsulated packet A to the gateway 126. As used here, an “unencapsulated packet” refers to a packet for which PAN encapsulation has not been applied.

A switch infrastructure in the gateway 126 can forward (at 418) unencapsulated packet A to a destination on an external network or on another VLAN.

Although not depicted in FIG. 4, the source AP 402 may decide to not encapsulate certain other types of packets, such as DHCP packets or ARP packets containing the destination IP address of the gateway 126.

As further shown in FIG. 4, the source client device 400 may send (at 420), to the source AP 402, packet B that has a unicast destination MAC address that identifies a destination device that is not the gateway 126 (in other words, the unicast destination MAC address does not match the gateway MAC address). Packet B is an intra-VLAN packet that is sent from the source client device to the destination device within the same VLAN.

Based on determining (at 422) that the unicast destination MAC address of packet B does not match the gateway MAC address, the forwarding engine in the source AP 402 makes a determination to perform PAN encapsulation. As a result of this determination to perform PAN encapsulation, the VTEP in the source AP 402 performs (at 424) PAN encapsulation by adding the PAN ID assigned to the source client device 400 to the GPI field of the VXLAN header that is added to packet B as part of the PAN encapsulation.

In the example of FIG. 4, it is assumed that a destination device 406 that is the destination of packet B is wirelessly connected to a destination AP 404 that is different from the source AP 402. The source AP 402 forwards (at 426) PAN encapsulated packet B to the destination AP 404.

The forwarding engine (similar to 114 in FIG. 1) in the destination AP 404 extracts (at 430) the PAN ID from the GPI field of the VXLAN header of PAN encapsulated packet B. The forwarding engine in the destination AP 404 determines (at 432) whether the extracted PAN ID matches the PAN ID of the destination device 406. For example, the forwarding engine in the destination AP 404 can retrieve an entry of a VLAN table (similar to 120 in FIG. 1) in the destination AP 404. The retrieved entry corresponds to the identifier (e.g., MAC address) of the destination device 406, and the retrieved entry correlates the identifier of the destination device 406 to the PAN ID assigned to the destination device 406.

If the forwarding engine in the destination AP 404 determines (at 432) that the extracted PAN ID does not match the PAN ID of the destination device, the forwarding engine in the destination AP 404 drops (at 434) packet B.

However, if the forwarding engine in the destination AP 404 determines (at 432) that the extracted PAN ID matches the PAN ID of the destination device 406, the VTEP (similar to 112 in FIG. 1) in the destination AP 404 decapsulates (at 436) encapsulated packet B to derive a decapsulated packet B. The destination AP 404 forwards (at 438) decapsulated packet B to the destination device 406.

In examples where the destination device 406 is connected to the same source AP 402 as the source client device 400, PAN encapsulation is not performed by the source AP 402 since the source AP 402 can make a determination whether the PAN ID of the destination device 406 matches the PAN ID of the source client device 400 based on accessing respective entries of the VLAN table (similar to 120 in FIG. 1) in the source AP 402.

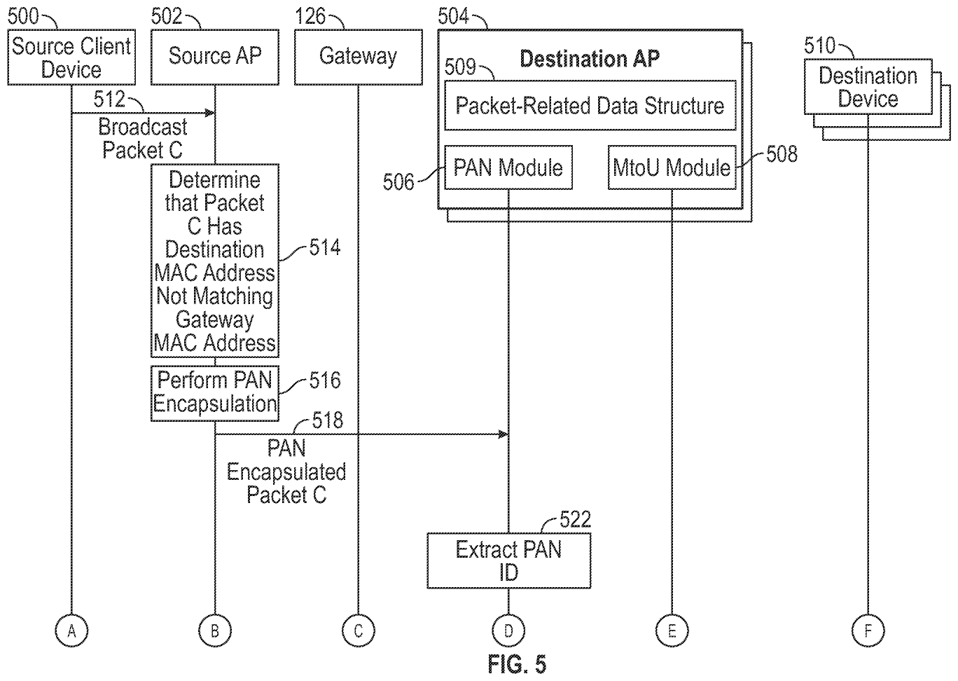

FIG. 4 assumes an example in which packet B is a unicast packet sent to a unicast MAC address. In a different example, as shown in FIG. 5, a packet may be a broadcast packet, which can refer to a (1) a packet that is sent to a broadcast address, or (2) a packet that is sent to a multicast address. Note that a “broadcast packet” can more generally refer to any packet that is to be delivered to more than one destination device. Techniques or mechanisms according to some implementations can be applied for any such broadcast packet. Although FIG. 5 shows a specific order of tasks, note that in other examples, the tasks may be performed in a different order, some of the tasks may be omitted, or other tasks may be added.

In FIG. 5, a source client device 500 (which can be any of client devices 106-1 or 106-2) sends (at 512), to a source AP 502, packet C that has a broadcast or multicast destination MAC address. Based on determining (at 514) that the broadcast or multicast destination MAC address of packet C does not match the gateway MAC address, the forwarding engine (similar to 114 in FIG. 1) in the source AP 502 makes a determination to perform PAN encapsulation. As a result of this determination to perform PAN encapsulation, the VTEP in the source AP 502 performs (at 516) PAN encapsulation by adding the PAN ID assigned to the source client device 500 to the GPI field of the VXLAN header that is added to packet C as part of the PAN encapsulation.

In the example of FIG. 5, it is assumed that at least some destination devices of broadcast packet C are wirelessly connected to one or more destination APs 504 that are different from the source AP 502. The source AP 502 forwards (at 518) PAN encapsulated packet C to the one or more destination APs 504.

The following describes operations of each of the one or more destination APs 504 that receive PAN encapsulated packet C from the source AP 402. Each destination AP 504 includes a PAN module 506 and an MtoU module 508. A “module” in an AP can refer to one or more hardware processing circuits of the AP, or alternatively, can refer to machine-readable instructions executable by a processing resource of the AP. The MtoU module 508 converts a broadcast packet to a unicast packet.

The PAN module 506 extracts (at 522) the PAN ID of the source client device 500 that is set in the GPI field of the VXLAN header of the PAN encapsulated packet C. The PAN module 506 saves (at 524) the extracted PAN ID to a packet-related data structure 509, which is a data structure associated with packet C. The packet-related data structure 509 is stored in a memory of the destination AP 504.

A VTEP of the PAN module 506 also decapsulates (at 526) PAN encapsulated packet C to derive decapsulated packet C.

Multiple destination devices 510 (associated with the broadcast or multicast MAC address of packet C) wirelessly connected to the destination AP 504 may be part of one or more basic service sets (BSSs), where a BSS refers to a subgroup of devices within a WLAN. A first BSS may be mapped to a source VLAN of the source client device 500, while a second BSS may not be mapped to the source VLAN of the source client device 500. For each given BSS mapped to the source VLAN of the source client device 500, the PAN module 506 invokes (at 528) the MtoU module 508. As part of the invocation of the MtoU module 508 for the given BSS, the PAN module 506 provides decapsulated packet C to the MtoU module 508. Note that the PAN module 506 does not invoke the MtoU module 508 for any BSS that is not mapped to the source VLAN of the source client device 500.

For each respective destination device 510 of the given BSS, the invoked MtoU module 508 checks (at 530) with the PAN module 506 to determine whether the respective destination device 510 is to receive decapsulated packet C. For example, the invoked MtoU module 508 can provide an identifier (e.g., MAC address) of the respective destination device 510 to the PAN module 506, which retrieves a corresponding entry from the VLAN table (similar to 120 in FIG. 1) of the destination AP 504. The PAN module 506 compares (at 532) the PAN ID of the respective destination device 510 in the retrieved entry to the saved PAN ID (saved in the packet-related data structure 509) of the source client device 500.

The PAN module 506 provides (at 534) a match indicator of whether the PAN ID of the respective destination device 510 matches the saved PAN ID of the source client device 500. The match indicator may be a message, a signal, an information element, or any other information. If the match indicator is set to a first value, that indicates the PAN IDs match. If the match indicator is set to a set to a different second value, that indicates the PAN IDs do not match.

For each respective destination device 510 for which the MtoU module 508 received the match indicator set to the first value, the MtoU module 508 creates (at 536) a unicast version of packet C (“unicast packet C”), and forwards (at 538) unicast packet C to the respective destination device. Unicast packet C contains a unicast destination MAC address of the respective destination device 510.

For any given destination device 510 for which the MtoU module 508 received the match indicator set to the second value, the MtoU module 508 makes a determination (at 540) to not forward packet C to the given destination device 510.

Tasks 528-540 are iterated for all destination devices that are part of each BSS mapped to the source VLAN of the source client device 500. If there are multiple BSSs mapped to the source VLAN, tasks 528-540 are reiterated for each of the multiple BSSs.

For any BSS that is not mapped to the source VLAN of the source client device 500, tasks 528-540 are not performed.

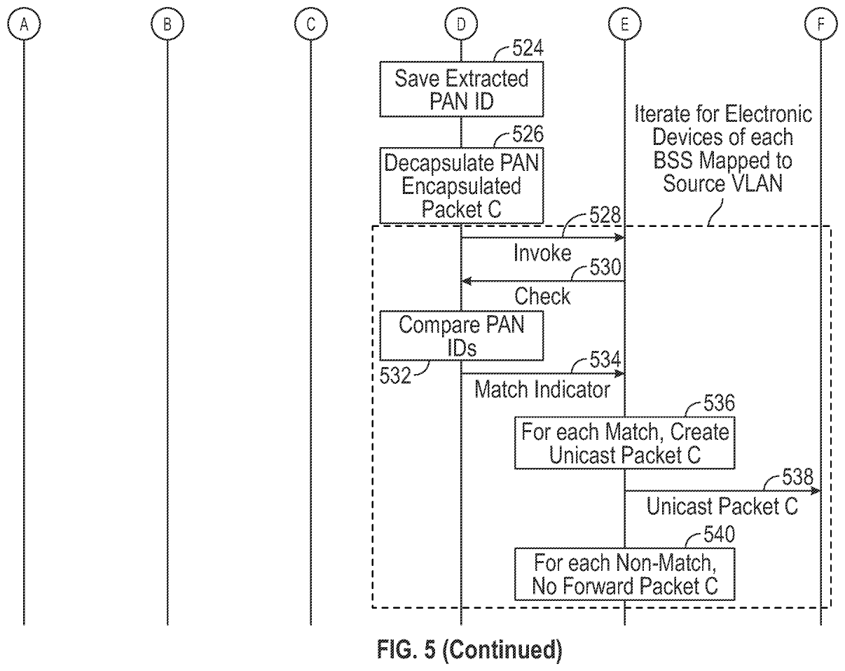

FIG. 6 is a block diagram of an arrangement that involves a transition of a client device 600 from a first AP 602 to a second AP 604. Initially, the client device 600 is wirelessly connected to the first AP 602. At a later time, the client device 600 may move (601) from the coverage area of the first AP 602 to the coverage area of the second AP 604, at which point the client device 600 is wirelessly connected to the second AP 604 and not to the first AP 602.

In some examples of the present disclosure, the client device 600 may be able to transition from the first AP 602 to the second AP 604 without having to perform re-authentication with an authentication server, such as the authentication server 130 of FIG. 1. Transitioning the client device 600 from the first AP 602 to the second AP 604 refers to a process in which the client device's connection to the first AP 602 is removed, and the client device 600 is associated with the second AP 604.

As shown in FIG. 6, the first AP 602 includes a memory 606, which may store a PAN ID 608 (or other community identifier) assigned to the client device 600, such as by an authentication server during an authentication procedure for the client device 600 with the authentication server while the client device 600 is wirelessly attached to the first AP 602.

When the client device 600 transitions from the first AP 602 to the second AP 604, a transition procedure performed between the first AP 602 and the second AP 604 for transitioning the client device 600 includes a message 610 sent from the first AP 602 to the second AP 604. The message 610 carries the PAN ID assigned to the client device 600. The PAN ID carried by the message 610 is the PAN ID 608 stored in the memory 606 of the first AP 602.

The second AP 604 includes a memory 612. In response to receiving the message 610, the second AP 604 extracts the PAN ID from the message 610 and stores the PAN ID as 614 in the memory 612. Because the PAN ID of the client device 600 is provided from the first AP 602 to the second AP 604 in the transition procedure, the second AP 604 would not trigger an authentication procedure to obtain the PAN ID of the client device 600 when the client device 600 transitions to the second AP 604.

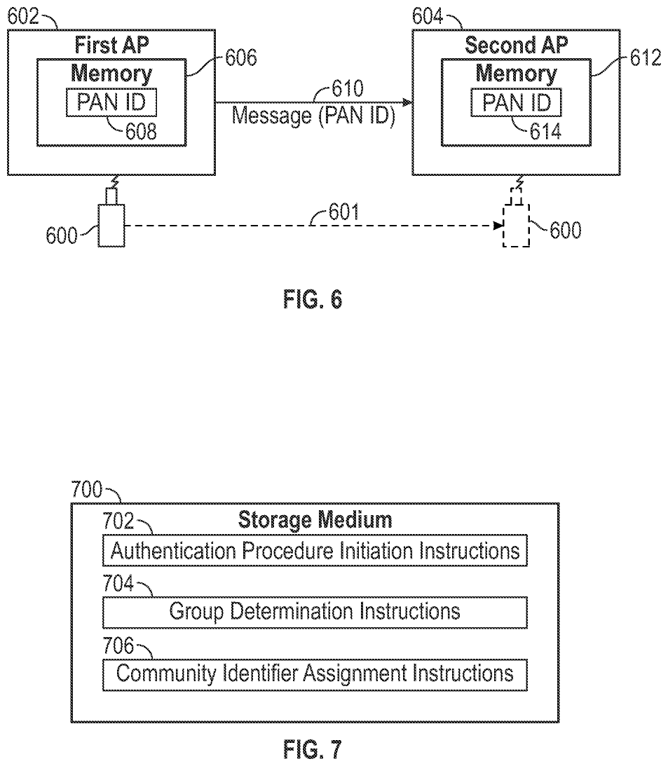

FIG. 7 is a block diagram of a non-transitory machine-readable or computer-readable storage medium 700 storing machine-readable instructions that upon execution cause a system to perform various tasks. In some examples, the “system” may refer to an authentication server, or a network device such as an AP, or both the authentication server and the network device. More generally, the “system” may refer to any collection of one or more computers.

The machine-readable instructions include authentication procedure initiation instructions 702 to initiate an authentication procedure for a client device. The initiation of the authentication procedure may be responsive to a network device detecting a connection of the client device to the network device, and to the client device providing credential information (e.g., 204 in FIG. 2) to the network device.

The machine-readable instructions include group determination instructions 704 to determine a group of client devices including the client device based on information associated with the client devices. The information associated with the client devices can include any or some combination of the following: information of a user to which a client device belongs, a type of a client device, a location of a client device, an organization that a client device is associated with, or any other information associated with a client device, or other information.

The machine-readable instructions include community identifier assignment instructions 706 to assign, to the client device, a community identifier as part of the authentication procedure. The community identifier identifies the group of client devices that are able to communicate with one another over a virtual network, such as a VLAN. The community identifier may be a PAN ID that identifies a PAN including the group of client devices, for example.

In some examples, the machine-readable instructions determine the community identifier based on a shared secret assigned to the group of client devices, where the shared secret is for use in secure communications between the client devices of the group of client devices and a network device.

In some examples, the shared secret includes an MPSK assigned to the group of client devices.

In some examples, the machine-readable instructions determine the community identifier based on accessing mapping information that correlates different shared secrets to corresponding different community identifiers.

In some examples, the machine-readable instructions receive, from the client device, an authentication message as part of the authentication procedure, the authentication message including user information of a user of the client device. The machine-readable instructions determine the community identifier based on the user information.

In some examples, the user information includes a username of the user of the client device, and possibly other information such as a password or a fingerprint of the password.

In some examples, the machine-readable instructions determine the community identifier based on accessing mapping information that correlates different user information to corresponding different community identifiers.

In some examples, the machine-readable instructions receive a first packet from the client device, determine whether a destination network address in the first packet matches a gateway network address of a gateway, based on determining that the destination network address in the first packet does not match the gateway network address, encapsulate the first packet with a header containing the community identifier, and forward the encapsulated first packet from the network device to the gateway.

In some examples, the machine-readable instructions receive a second packet from the client device, determine whether a destination network address in the second packet matches the gateway network address, and based on determining that the destination network address in the second packet matches the gateway network address, forward the second packet from the network device to the gateway without encapsulating the second packet with a header including the community identifier.

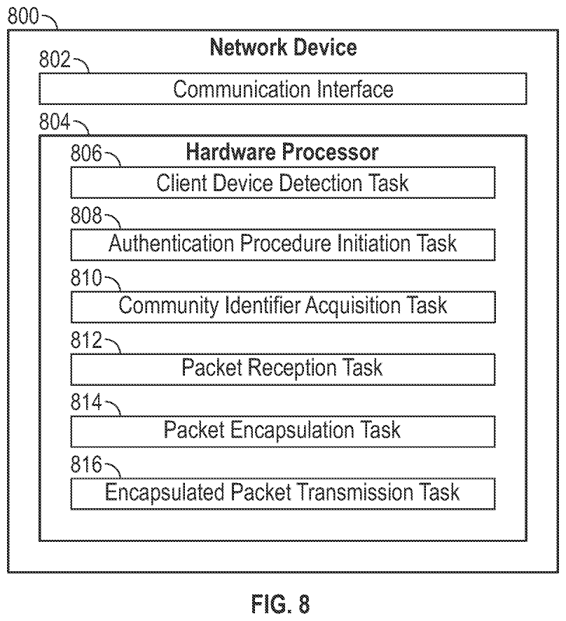

FIG. 8 is a block diagram of a network device 800 according to some examples. The network device 800 may be an AP or another type of network device, such as a switch. The network device 800 includes a communication interface 802 to communicate with a client device. If the network device 800 is a wireless network device such as an AP, the communication interface 802 is able to wirelessly communicate with the client device. If the network device 800 is a wired network device, the communication interface 802 is able to perform wired communications with the client device. The communication interface 802 includes a transceiver to transmit and receive signals over a communication link, and any protocol layers to support communications according to one or more communication protocols.

The network device 800 includes a hardware processor 804 (or multiple hardware processors) to perform various tasks. A hardware processor can include a microprocessor, a core of a multi-core microprocessor, a microcontroller, a programmable integrated circuit, a programmable gate array, or another hardware processing circuit. A hardware processor performing a task can refer to a single hardware processor performing the task or multiple hardware processors performing the task. The tasks of the hardware processor 804 may be performed by machine-readable instructions executed on the hardware processor 804.

The tasks of the hardware processor 804 include a client device detection task 806 to detect that the client device has connected to the network device 800. The tasks of the hardware processor 804 include an authentication procedure initiation task 808 to initiate an authentication procedure with an authentication server for the first client device.

The tasks of the hardware processor 804 include a community identifier acquisition task 810 to obtain, at the network device 800 as part of the authentication procedure, a community identifier assigned to the first client device, where the community identifier identifies a group of client devices including the client device that are able to communicate with one another over a virtual network.

The tasks of the hardware processor 804 include a packet reception task 812 to receive, at the network device, a packet from the client device. The tasks of the hardware processor 804 include a packet encapsulation task 814 to encapsulate, by the network device, the packet in a header, the header including the community identifier, the encapsulating producing an encapsulated packet.

The tasks of the hardware processor 804 include an encapsulated packet transmission task 816 to cause transmission, from the network device, of the encapsulated packet for forwarding to a destination device.

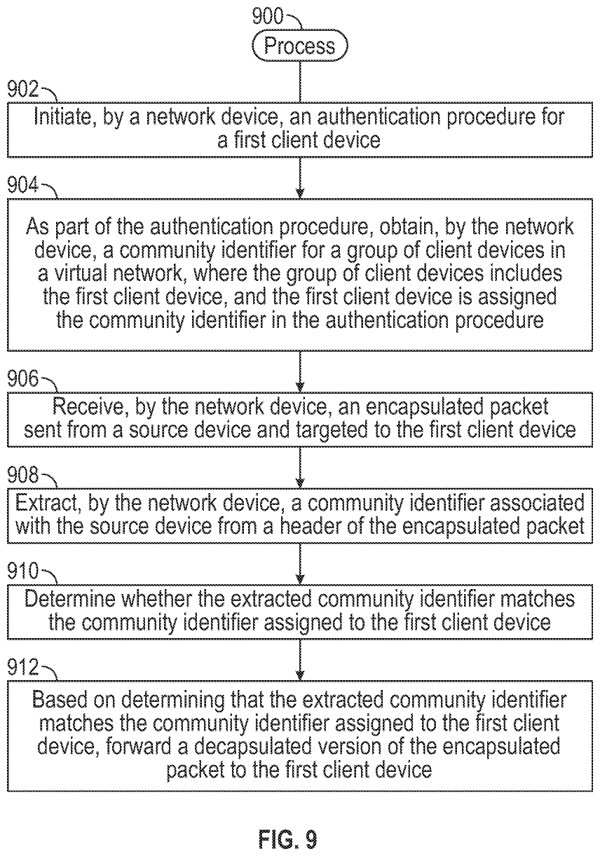

FIG. 9 is a flow diagram of a process 900 according to some examples. The process 900 includes initiating (at 902), by a network device, an authentication procedure for a first client device. The authentication procedure is initiated with an authentication server, such as the authentication server 130 of FIG. 1.

As part of the authentication procedure, the process 900 obtains (at 904), by the network device, a community identifier for a group of client devices in a virtual network, where the group of client devices includes the first client device, and the first client device is assigned the community identifier in the authentication procedure. The network device may obtain the community identifier from the authentication server, such as in an authentication message. Alternatively, the network device may assign the community identifier to the first client device based on information of the authentication procedure.

The process 900 includes receiving (at 906), by the network device, an encapsulated packet sent from a source device and targeted to the first client device. The source device may be connected to another network device. The encapsulated packet may be passed through a switch infrastructure (e.g., in a gateway) from the other network device to the network device to which the first client device is connected.

The process 900 includes extracting (at 908), by the network device, a community identifier associated with the source device from a header of the encapsulated packet. For example, the community identifier may be extracted from a GPI field of a VXLAN header.

The process 900 includes determining (at 910) whether the extracted community identifier matches the community identifier assigned to the first client device. Based on determining that the extracted community identifier matches the community identifier assigned to the first client device, the process 900 includes forwarding (at 912) a decapsulated version of the encapsulated packet to the first client device.

In some examples, responsive to the first client device transitioning from the network device to a further network device, the process 900 includes transmitting, as part of a transition procedure to transition the first client device from the network device to the further network device, the community identifier assigned to the first client device.

A storage medium (e.g., 700 in FIG. 7) can include any or some combination of the following: a semiconductor memory device such as a DRAM or SRAM, an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
initiate an authentication procedure for a client device;
determine a group of client devices including the client device based on information associated with the client devices; and
assign, to the client device, a community identifier as part of the authentication procedure, wherein the community identifier identifies the group of client devices that are able to communicate with one another over a virtual network.

2. The non-transitory machine-readable storage medium of claim 1, wherein the community identifier comprises a personal area network (PAN) identifier that identifies a PAN including the group of client devices.

3. The non-transitory machine-readable storage medium of claim 1, wherein the instructions upon execution cause the system to:
determine the community identifier based on a shared secret assigned to the group of client devices, the shared secret for use in secure communications between the client devices of the group of client devices and a network device.

4. The non-transitory machine-readable storage medium of claim 3, wherein the shared secret comprises a Multi Pre-Shared Key (MPSK).

5. The non-transitory machine-readable storage medium of claim 3, wherein the instructions upon execution cause the system to determine the community identifier based on accessing mapping information that correlates different shared secrets to corresponding different community identifiers.

6. The non-transitory machine-readable storage medium of claim 1, wherein the instructions upon execution cause the system to:
receive, from the client device, an authentication message as part of the authentication procedure, the authentication message comprising user information of a user of the client device; and
determine the community identifier based on the user information.

7. The non-transitory machine-readable storage medium of claim 6, wherein the user information comprises a username of the user of the client device.

8. The non-transitory machine-readable storage medium of claim 6, wherein the instructions upon execution cause the system to:
determine the community identifier based on accessing mapping information that correlates different user information to corresponding different community identifiers.

9. The non-transitory machine-readable storage medium of claim 6, wherein the authentication message comprises a Remote Authentication Dial-In User Service (RADIUS) message, and wherein the user information is included in a vendor-specific attribute (VSA) of the RADIUS message.

10. The non-transitory machine-readable storage medium of claim 1, wherein the instructions upon execution cause the system to:
receive a first packet from the client device;
determine whether a destination network address in the first packet matches a gateway network address of a gateway;
based on determining that the destination network address in the first packet does not match the gateway network address, encapsulate the first packet with a header containing the community identifier; and
forward the encapsulated first packet from the system to a destination device.

11. The non-transitory machine-readable storage medium of claim 10, wherein the instructions upon execution cause the system to:
receive a second packet from the client device;
determine whether a destination network address in the second packet matches the gateway network address; and
based on determining that the destination network address in the second packet matches the gateway network address, forward the second packet from the system to the gateway without encapsulating the second packet with a header including the community identifier.

12. The non-transitory machine-readable storage medium of claim 10, wherein the encapsulating of the first packet comprises a Virtual extensible LAN (VXLAN) encapsulation of the first packet, and the header comprises a VXLAN header.

13. The non-transitory machine-readable storage medium of claim 12, wherein the community identifier is included in a group policy identifier (GPI) field of the VXLAN header, and wherein the community identifier in the GPI field comprises a personal area network (PAN) identifier.

14. The non-transitory machine-readable storage medium of claim 1, wherein the system comprises an authentication server or an access point (AP) of a wireless local area network (WLAN).

15. A method comprising:
initiating, by a network device, an authentication procedure for a first client device;
as part of the authentication procedure, obtaining, by the network device, a community identifier for a group of client devices in a virtual network, the group of client devices comprising the first client device, and the first client device being assigned the community identifier in the authentication procedure;
receiving, by the network device, an encapsulated packet sent from a source device and targeted to the first client device;
extracting, by the network device, a community identifier associated with the source device from a header of the encapsulated packet;
determining whether the extracted community identifier matches the community identifier assigned to the first client device;
based on determining that the extracted community identifier matches the community identifier assigned to the first client device, forward a decapsulated version of the encapsulated packet to the first client device.

16. The method of claim 15, wherein the community identifier assigned to the first client device comprises a personal area network (PAN) identifier, the method comprising:
including, by the network device, the PAN identifier in a field of a header of a given packet as part of encapsulating the given packet.

17. The method of claim 16, further comprising:
responsive to the first client device transitioning from the network device to a further network device, transmitting, as part of a transition procedure to transition the first client device from the network device to the further network device, the community identifier assigned to the first client device.

18. The method of claim 16, further comprising:
determining the group of client devices based on information associated with the client devices, wherein the information comprises one or more of:
a user or collection of users that the client devices are associated with,
a type of the client devices,
locations of the client devices, or
an organization that the client devices are associated with.

19. A network device comprising:
a communication interface to communicate with a first client device; and
a processor to:
detect that the first client device has connected to the network device;
initiate an authentication procedure with an authentication server for the first client device;
obtain, at the network device as part of the authentication procedure, a community identifier assigned to the first client device, wherein the community identifier identifies a group of client devices including the first client device that are able to communicate with one another over a virtual network;
receive, at the network device, a packet from the first client device;
encapsulate, by the network device, the packet in a header, the header including the community identifier, the encapsulating producing an encapsulated packet; and
cause transmission, from the network device, of the encapsulated packet for forwarding to a destination device.

20. The network device of claim 19, wherein the community identifier comprises a personal area network (PAN) identifier of a PAN that the first client device is part of.
